(19) United States
(12) Patent Application Publication
(10) Pub. No.: US 2020/0215671 A1
(43) Pub. Date: Jul. 9, 2020

(54) Operating tool and/or measuring device with sim card

(71) Applicant: STAHLWILLE Eduard Wille GmbH & Co. KG, Wuppertal (DE)

(72) Inventors: Winfried CZILWA, Herborn (DE); Jürgen BUSMANN, Ahaus (DE)

(73) Assignee: STAHLWILLE Eduard Wille GmbH & Co. KG, Wuppertal (DE)

(21) Appl. No.: 16/648,586

(22) PCT Filed: Oct. 18, 2018
(86) PCT No.: PCT/DE2018/100856

§ 371 Date: Mar. 18, 2020

(30) Foreign Application Priority Data
Oct. 20, 2017 (DE) 20 2017 106 362.3

(51) Int. Cl. B25B 23/147; H04W 12/06; G01D 7/00; H04L 9/32; H04W 4/70; H04W 4/02

(52) U.S. Cl. CPC B25B 23/147; H04W 12/06; H04W 4/02; H04L 9/3234; H04W 4/70; G01D 7/002

(57) ABSTRACT

The disclosure relates to a communication device (36, 72, 74, 78) for an operating tool (10, 68, 70) and/or for a measuring device to transmit data between the operating tool (10, 68, 70) and the measuring device and a data processing system (62, 66). The communication device (36, 72, 74, 78) comprises an authentication module (42) for authentication of the operating tool (10, 68, 70) and/or of the measuring device when transmitting data. A transmission module (38) transfers the data over a mobile network (40) via Internet connections. The invention further relates to an operating tool (10, 68, 70) and/or measuring device with means (76) for generating user data and/or usage data with a communication device (36, 72, 74, 78) for exchanging data between the operating tool and/or measuring device and a data processing system (62, 66).

### TECHNICAL FIELD

The disclosure relates to a communication device for an operating tool and/or for a measuring device for transmitting data between the operating tool and/or the measuring device and a data processing system. Furthermore, the disclosure relates to an operating tool and/or measuring device with means for generating user data and/or usage data with a communication device for exchanging data between the operating tool and/or the measuring device and a data processing system.

### BACKGROUND

Mobile devices such as mobile phones or smartphones have become a constant companion in everyday private and professional life. With such a mobile device, a user has the ability to communicate with other mobile devices over a cellular network. In addition to voice communication, it is also possible to access web pages and send emails, other digital messages, or data.

To be able to communicate over the mobile network, authentication of the mobile device must be performed between the mobile network and the mobile network operator. This authentication process is performed using a uniquely assigned SIM (Subscriber Identity Module) card. A SIM card is a chip card that is inserted into the mobile device. The data on the SIM card are queried using suitable protocols and transmitted to the mobile network operator over the mobile network, provided the mobile device is connected to the mobile network. A communication connection can only be established after the mobile device has been authenticated.

Today, such SIM cards are only built into mobile devices in the form of chips. For example, the automobile industry uses this mobile network technology to transmit the status of vehicles to the manufacturer.

Screw connections are the most commonly used connections in mechanical engineering. Such connection elements can only effective through the use of suitable assembly tools. Assembly tools suitable for this purpose include torque tools like the torque screwdriver.

Torque tools are needed to achieve a specific torque on a workpiece. Torque wrenches and torque screwdrivers are commonly known torque tools, for example. There are mechanical and electronic torque tools. On particular, there are dial torque tools and breaking torque tools. Dial torque tools always show the current torque of a connection. A target torque value is set on breaking torque tools. As soon as this torque is reached when tightening a threaded connection, the torque tool indicates to the user that the target torque has been reached. This can be indicated by an audible click or a noticeable deflection of the tool. The torque tool can also be triggered and separate the torqued connection.

The torque to be transferred when using manually operated tools depends on the physical condition of the user as well as on their subjective sensitivity to force. Torque tools are used to tighten a screw or bolt using a high tightening force, that lies within the elastic range of screw or bolt or to ensure the screw is only tightened with a minimal tightening force. The use of new construction materials like magnesium, aluminum, or plastic in lightweight designs in the automobile or aviation industries, for example, is increasing the demand for torque tools as well as the requirements placed on torque tools. Due to these new materials, the number of sensitive threaded connections is increasing. The low tensile strength of these lightweight design materials as compared to steels leads to damaged threads on the threaded connection if tightened too tightly, which then renders these expensive components useless.

The patent DE 10 2013 113 270 A1 describes a method for controlling the use of services available for communication connections in a mobile network by a mobile device. In this case, the mobile device uses a subscriber identity module to obtain access to the mobile network. A telephone exchange in a mobile network serves to control the use of services available for communication connections in a mobile network by a mobile device. In this case, the mobile device uses a subscriber identity module to obtain access to the mobile network. In addition, a mobile device for the use of services available for communication connections in a mobile network is described. The mobile device also uses a subscriber identity module to obtain access to the mobile network.

Patent DE 2020 140 00041 describes a breaking torque tool. The torque tool contains a shaft-like housing with a grip area and a head section. Furthermore, a transfer assembly is provided in the housing to transfer the torque. The torque is set with an actuating device having an adjusting knob to indicate when the target torque has been reached. A display shows the value of the torque at which the torque tool should break away. Furthermore, a breaking mechanism is provided. With the breaking mechanism, the torque tool breaks away at the previously set torque.

Tools equipped with a SIM card as an authentication module and a communication device are also known from DE 10 2014 217 880 A1. It is not always possible to obtain the exact position of the tool via triangulation, which is possible in cellular networks to determine the position of a mobile device. It is often important for documentation purposes, though, to know when and where which tool was used.

### SUMMARY

A purpose of the disclosure is to produce an operating tool and/or measuring device which avoids the disadvantages of the current state of the art and allows a manufacturer or a user to remotely maintain, calibrate, adjust, and control such a tool and/or device with an exact identification and in an exact position.

This task is achieved in that a communication device for an operating tool and/or for a measuring device of the type mentioned previously is provided with an authentication module to authenticate the operating tool and/or measuring device during the data transmission. Furthermore, the task is achieved by an operating tool and/or measuring device with means for generating user data and/or usage data and with a communication device of the type mentioned previously is provided with a GPS receiver for satellite-based positioning to generate positioning data.

The disclosure is based on the principle that operating tools and measuring devices can be adjusted, controlled, or calibrated individually at any location. The use, status, or application of the operating tool and/or measuring device can also be controlled in this manner. This also includes the ability to switch an individual operating tool or measuring device off so that it is not operable any more. To uniquely identify a tool, the tool must authenticate itself accordingly. This authentication process is performed by the authentication module. During a data transmission, the data transmitted shall be unambiguously associated with the operating tool or the measuring device. Accordingly, individual parameters for the adjustment or calibration of the operating tool and/or measuring device can also be transmitted by the manufacturer, for example.

For documentation purposes, it is now possible with satellite-based GPS (Global Positioning System) to determine the position with extreme accuracy. This makes it possible to associate the tightening torques of bolts to exactly one wind turbine in a wind park, for example. In terms of the required documentation, this is a significant simplification for users because associating tightening torques to a wind turbine can be performed automatically now based on its position. Precise determination of the position also protects against theft. For example, a tool that transmits its position automatically or whose exact position can be queried cannot be stolen very easily. In addition, it is also possible to prove that a tool and/or measuring device was potentially misused based on the determination of the position. This is especially useful for loaned or rented tools or measuring devices.

The communication device comprises a transmission module to transmit the data over a mobile network. The communication device can be used anywhere where there is a cellular mobile network available. Using the authentication module, it is possible to authenticate the operating tool and/or measuring device in the mobile network. For the provider of the mobile network and for the manufacturer and/or user, the operating tool and/or measuring device is uniquely identified in this case. The operating tool and/or the measuring device can exchange data over the mobile network such that the data can be clearly associated with the tool and/or measuring device. If no mobile network is available in the vicinity, then it is possible to store the position data in a memory storage device. Data is read directly from the memory storage device or the communication device sends the position data with the user data as soon as the tool and/or measuring device is located in a cell of a mobile network.

Alternatively or in combination with sending the data, the communication device for an operating tool and/or for a measuring device can also be provided with a transmission module to transmit the data over an Internet connection. The Internet connection can also be established over a cable or wirelessly over a WLAN. The Internet connection can also be established over cellular mobile networks. The communication device for the operating tool and/or the measuring device can authenticate itself over the Internet. This also makes it possible to uniquely identify the communication device over the Internet as a global network using the authentication module.

An advantageous embodiment of the disclosure is that the communication device is formed as a separate unit which can be mounted on and removed from the operating tool and/or measuring device. This embodiment is especially useful in that the communication device can be used with different operating tools and/or measuring devices. It is preferably fastened to the particular operating tool and/or measuring device using a suitable locking mechanism only so that the communication device can only be removed with a suitable key or tool.

The communication device preferably operates autonomously to the greatest extent possible. It therefore has its own power supply. The power supply can be formed by a battery. The battery is either charged by an external power source or charged by a power supply of the operating tool and/or of the measuring device. If necessary, the communication device is provided with a backup power supply that maintains the voltage while replacing the battery. This backup power supply can also be a commercially available battery.

In a preferred embodiment of the communication device for an operating tool and/or measuring device, the operating tool and/or measuring device is provided with means for generating user data and/or usage data for transmission. In this embodiment, the operating tool and/or the measuring device generates user data and usage data such as user names or status data, the use of the operating tool and/or measuring device, the duration of use, position data, and any other usage data necessary. This data can be evaluated centrally practically anywhere in the world. The operating tool and/or measuring device can then be adapted accordingly to its usage, if necessary.

In a preferred embodiment of the communication device, the operating tool and/or measuring device can be controlled, adjusted, or calibrate via the communication device. This enables the operating tool and/or measuring device to be controlled remotely even though the tool could be located anywhere.

Another expedient embodiment of the disclosure is that the communication device is provided with an encryption system to encrypt the data transmitted. It is possible that the data to be transmitted contains confidential material. To prevent unauthorized persons from accessing the data, the encryption system encrypts the data. Encryption can be performed using a cryptographic algorithm, for example. This permits the use of the communication device in applications with high security requirements.

In a special embodiment of the communication device, the operating tool and/or the measuring device are formed as a torque measurement tool. Torque measurement tools can be classified as operating tools and/or as measuring devices. Torque measurement tools often have processor-controlled electronics that can also be used for the communication device.

In a preferred embodiment of the operating tool and/or measuring device according to the invention, it is provided with a transmission module to transmit the data over a mobile network. In this embodiment, the communication device can be used anywhere where there is a cellular mobile network available. Using the authentication module, it is possible to authenticate the operating tool and/or measuring device in the mobile network. For the provider of the mobile network and for the manufacturer and/or user, the operating tool and/or measuring device is uniquely identified in this case. The operating tool and/or the measuring device can exchange data over the mobile network such that the data can be clearly associated with the tool and/or measuring device. Of course, the communication device for an operating tool and/or for a measuring device can also be provided with a transmission module to transmit the data over an Internet connection. The Internet connection can also be established over a cable or wirelessly over a WLAN. The Internet connection can generally also be established over cellular mobile networks.

Another advantageous embodiment of the operating tool and/or measuring device is that the operating tool and/or measuring device is formed so that it can be controlled, adjusted, or calibrated over the communication device. In this manner, the operating tool and/or measuring device can be operated remotely at least in part. It is then possible to define values remotely and transmit them to the operating tool and/or the measuring device, for example to set a parameter to a specific value or adjust other parameters.

In another expedient embodiment of the disclosure, the operating tool and/or the measuring device are formed as a torque measurement tool. Torque wrenches and torque screwdrivers are operating tools, for example to tighten threaded connections, as well as measuring devices, for example to measure the torque applied. These torque measurement tools must be adjusted, calibrated, and set a predefined torque. One aspect in this regard is that the torque tool can be accessed individually from a remote location via the communication device. This allows the torque tool to be controlled and operated. Due to the communication device, the torque measurement tool can also be designed to be adjustable and calibratable.

A preferred embodiment of the operating tool and/or measuring device is that the communication device is provided so that it can be removed from the operating tool and/or measuring device. This also enables older tools and/or measuring devices that do not have an integrated communication device to be equipped with such a device. This also makes replacing the communication device easier. In this preferred embodiment, the communication device can be mounted and locked on the operating tool and/or measuring device if necessary using a suitable locking mechanism so that users cannot remove it.

Additional embodiments and advantages result from the object of the subclaims and from the drawings with the associated descriptions. Exemplary embodiments are explained in more detail with reference to the enclosed drawings. The invention should not be restricted to this list of exemplary embodiments alone. Indeed, embodiments are also envisioned that could be realized now and in the future in an equivalent manner by skilled persons with other technical means as well.

### BRIEF DESCRIPTION OF THE DRAWINGS

FIG. 1 is a diagram of torque measurement tools with a communication device that is integrated into the housing and are located in a mobile network and in a WLAN.

FIG. 2 is a diagram of a torque measurement tool with a communication device that is integrated into the housing.

FIG. 3 is a diagram of a torque measurement tool with a communication device that is docked on the housing.

### DETAILED DESCRIPTION

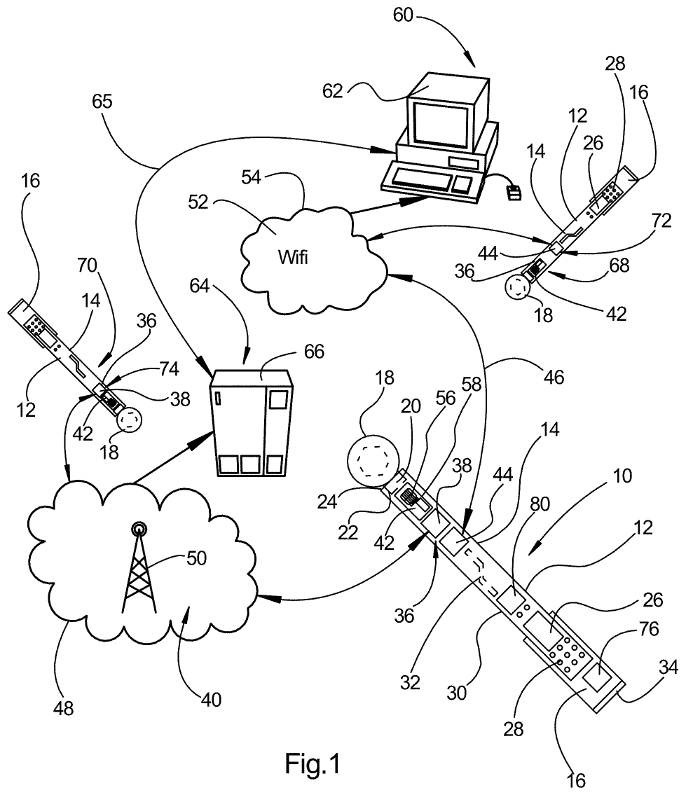

In FIG. 1, number 10 designates an operating tool and/or measuring device. This figure simultaneously shows three different application scenarios. The operating tool 10 and/or measuring device is a torque wrench 12 for tightening threaded connections and for measuring the particular torque with which the bolt or screw is tightened.

The torque wrench 12 comprises a shaft portion 14, a handle portion 16, and an attachment 18 to transfer a torque. The attachment 18 is provided with an insertion shaft 20, which is inserted in a recess 22 on the front end 24 of the shaft portion 14.

In the handle portion 16 there is a display 26 from which a user can read the torque values or other settings. Corresponding adjustments can be made by means of an operating panel 28. The shaft portion 14 and the handle portion 16 form a housing 30. A lever arrangement 32 to transfer the torque is indicated in the housing 30. The torque wrench 12 breaks away upon reaching a torque and thereby indicates that a desired torque has been reached. The breakaway can be triggered mechanically or electronically. A user can make fine adjustments if necessary using an adjustment knob 34.

A separate power supply 35 supplies a communication device 36. In the present exemplary embodiment, the communication device 36 is integrated into the housing 30. The communication device 36 can also be formed as a separate unit in a separate housing which can be removably fastened to the torque wrench 12. To prevent the communication device 36 from being removed, a lockable or closable mechanism for the communication device 36 can be provided. The communication device 36 further comprises a transmission module 38 for a cellular mobile network 40, a GPS receiver 39, an authentication module 42, and a WiFi transmission module 44 for a WLAN connection 46. The mobile network 40 is shown symbolically as a cloud 48 with a cell tower 50. A skilled person is familiar with how a cellular network with mobile network cells, for example based on the 2G, 3G, or even 4G standard, functions. By means of the authentication module 42, it is possible for the operating tool 10 to authenticate itself as a mobile device in the mobile network 40. This allows the operating tool 10 to be uniquely identified by others. The GPS receiver 39 continuously supplies position data so that the position of the torque wrench 12, and therefore the corresponding location of use, can be determined. Using the usage and location data, it is possible to precisely document the use of the tool.

With the WiFi transmission module 44 the communication device 36 can also be integrated into a local area network 52 for connection to a WLAN 46. The local area network 52 is also shown symbolically as a cloud 54. In this case as well, the authentication module 42 helps to identify and designate the operating tool 10. Via the WLAN connection 46, the operating tool 10 can establish a connection for exchanging data over the Internet provided that the local area network 52 is connected to the Internet, for example via a suitable router.

The authentication module 42 in the present exemplary embodiment comprises a SIM card 56, which is inserted in a special card slot 58. The SIM card 56 can be read by the authentication module 42 to authenticate the operating tool 10. Instead of using the SIM card 56 inserted in the card slot 58, it is also possible to use an identification chip that is permanently soldered in the communication device 36. Said chip would make manipulations during authentication more difficult.

Over the local area network 52, a user company 60 for example, which is shown here symbolically as a computer 62, can access the operating tool 10 via the communication device 36. This allows data to be exchanged and adjustments to be made from a remote location.

A manufacturer 64, shown in the diagram as a data processing system 66, of an operating tool 10 can access the operating tool 10 directly over the mobile network 40. As a result of this, the manufacturer 64 has the ability to service the operating tool 10 and also shut it down, if necessary, in the event that a defect is detected, for example. The manufacturer 64 also has the ability to provide the user with assistance while performing his or her tasks. The display 26 can also be used for this purpose to provide the user with information. Via connection 65, e.g. via a landline or cable, the user 60 and manufacturer 64 can exchange data when needed.

This figure also shows two additional operating tools 68 and 70. The operating tool 68 has a communication device 72, which is only able to establish a WLAN connection 46 with the local area network 52. A separate power supply 73 supplies the communication device 72 with power. The power supply 73 is independent of the operating tool 68. If desired, though, the power source, like the one used for operating tool 70, can be used to design the communication device 72 to be more compact, if this is necessary. For this reason, the communication device 72 only contains one WiFi transmission module 44. The operating tool 70 contains a communication device 74 that can only establish a connection via the mobile network 40. These two additional variants are intended to demonstrate that this embodiment can also be used for different applications or be subject to different restrictions.

Via the authentication module 42, it is possible in all cases to uniquely identify the operating tools 10, 68, and 70 not only in the mobile network 40 or in the local area network 52. Anyone who has access to the operating tools 10, 68, or 70 can uniquely identify themselves via the authentication module 42. Measured torque values and/or status values and/or position data of the torque wrench 12 and/or other user or usage data are generated with means 76 and can then be transmitted. The data transmitted can be unambiguously associated with the torque wrench 12 in the data processing system 66 and/or in the computer 62. This allows detailed documentation of the use of the operating tool to be created. To enable the data to be transmitted confidentially, an encryption system 80 is provided. The encryption system 80 encodes and decodes the data to be sent and received, respectively.

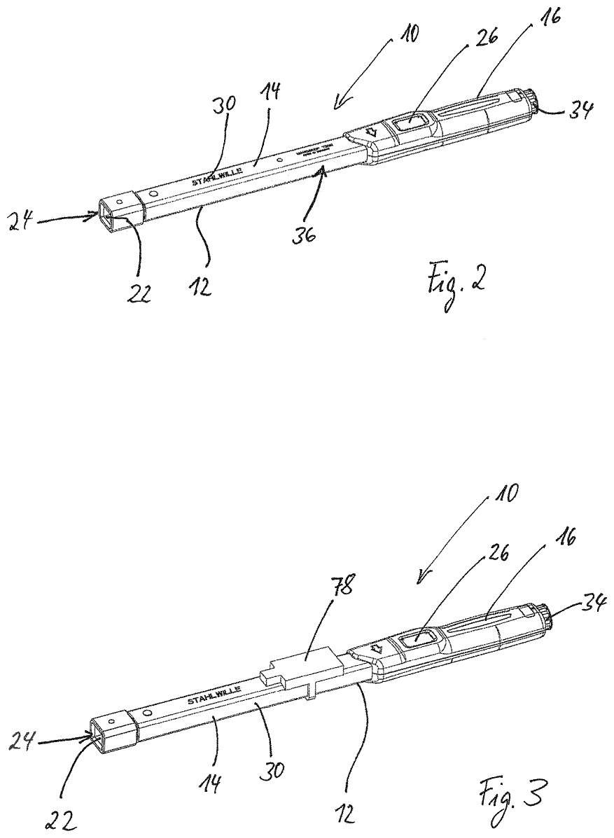

In FIG. 2 the operating tool 10 is shown in which the communication device 36 is integrated into the housing 30. In this figure, the operating tool 10 corresponds to a torque wrench 12 according to FIG. 1. Matching parts in the two figures are assigned the same reference number. Torque wrench 12 in this case also comprises a shaft portion 14 and a handle portion 16. The attachment 18 is not shown in this figure. Because the communication device 36 is integrated into the housing 30 of torque wrench 10, it is possible to manufacture an especially compact operating tool 10. As a result of this, it is less susceptible to unwanted external mechanical or chemical influences.

FIG. 3 shows the operating tool 10 with a dockable communication device 78. The operating tool 10 is a torque wrench 12 again whose method of operation corresponds to the method of operation of the operating tools in the previous figures. In contrast to the previous figures, though, the communication device 78 is arranged in the housing 30, but is docked to the outside of the shaft portion 14. As a result of this, it is also possible to equip an older torque wrench 12 in particular with a communication device 78. In this preferred embodiment, the communication device 78 can be mounted and locked on the operating tool 10 if necessary using a suitable locking mechanism so that users cannot remove it.

### LIST OF REFERENCE SIGNS

10 Operating tool

12 Torque wrench

14 Shaft portion

16 Handle portion

18 Attachment

20 Insertion shaft

22 Recess

24 Front end

26 Display

28 Operating panel

30 Housing

32 Lever arrangement

34 Adjustment knob

35 Power supply

36 Communication device

38 Transmission module

39 GPS receiver

40 Cellular mobile network

42 Authentication module

44 WiFi transmission module

46 WLAN connection

48 Cloud of the mobile network

50 Cell tower

52 Local area network

54 Cloud of the local area network

56 SIM card

58 Card slot

60 User company

62 Computer

64 Manufacturer

65 Connection

66 Data processing system

68 Operating tool

70 Operating tool

72 Communication device

73 Power supply

74 Communication device

76 Means of generating user data or usage data

78 Dockable communication device

80 Encryption system

1.-12. (canceled)

13. A communication device (36, 72, 74, 78) for an operating tool (10, 68, 70) and/or for a measuring device to transmit data between the operating tool (10, 68, 70) and/or the measuring device and a data processing system (62, 66),
wherein an authentication module (42) is provided for authentication of the operating tool (10, 68, 70) and/or the measuring device during data transmission and
wherein a transmission module (38) is provided for transmission of the data over a mobile network (40) and/or a transmission module (44) is provided for transmission of the data over Internet connections, and
wherein a GPS receiver (39) is provided for satellite-based position determination for generating position data.

14. The communication device (36, 72, 74, 78) for an operating tool (10, 68, 70) and/or measuring device according to claim 13,
wherein the communication device (36, 72, 74, 78) is formed as a separate unit which can be mounted on and removed from the operating tool (10, 68, 70) and/or measuring device.

15. The communication device (36, 72, 74, 78) for an operating tool (10, 68, 70) and/or measuring device according to claim 13, wherein the device is provided with a power supply (35, 73).

16. The communication device (36, 72, 74, 78) for an operating tool (10, 68, 70) and/or measuring device according to claim 13,
wherein the operating tool (10, 68, 70) and/or measuring device is provided with means (76) to generate user and/or usage data to be transmitted.

17. The communication device (36, 72, 74, 78) for an operating tool (10, 68, 70) and/or measuring device according to claim 13,
wherein the operating tool (10, 68, 70) and/or measuring device is designed so that it can be controlled and/or adjusted and/or calibrated via the communication device (36, 72, 74, 78).

18. The communication device (36, 72, 74, 78) for an operating tool (10, 68, 70) and/or measuring device according to claim 13,
wherein said device is provided with and encryption system (80) to encrypt the data transmitted.

19. The communication device (36, 72, 74, 78) for an operating tool (10, 68, 70) and/or measuring device according to claim 13,
wherein the operating tool (10, 68, 70) and/or measuring device is formed as a torque measurement tool (12).

20. An operating tool (10, 68, 70) and/or a measuring device with means (76) for generating user data and/or usage data and with a communication device (36, 72, 74, 78) for exchanging data between the operating tool and/or the measuring device and a data processing system (62, 66),
wherein an authentication module (42) is provided for authentication of the operating tool (10, 68, 70) and/or measuring device when transmitting data, and
wherein a transmission module is provided to transfer the data over a mobile network (40), and
wherein the communication device (36, 72, 74, 78) is provided with a GPS receiver (39) for satellite-based position determination for generating position data.

21. The operating tool (10, 68, 70) and/or measuring device according to claim 20,
wherein the operating tool (10, 68, 70) and/or measuring device and the communication device (36, 72, 74, 78) are formed as separate units.

22. The operating tool (10, 68, 70) and/or measuring device according to claim 20,
wherein the communication device (36, 72, 74, 78) is formed as a separate unit which can be mounted on and removed from the operating tool (10, 68, 70) and/or measuring device.

23. The operating tool (10, 68, 70) and/or measuring device according to claim 20,
wherein the operating tool and/or measuring device is designed so that it can be controlled and/or adjusted and/or calibrated via the communication device (36, 72, 74, 78).

24. The operating tool (10, 68, 70) and/or measuring device according to claim 20,
wherein the operating tool (10, 68, 70) and/or measuring device is formed as a torque measurement tool (12).
